(19) United States
(12) Patent Application Publication
(10) Pub. No.: US 2017/0212855 A1
(43) Pub. Date: Jul. 27, 2017

(54) Systems and Methods for Transfer Margin Communication

(71) Applicant: Avago Technologies General IP (Singapore) Pte. Ltd, SINGAPORE (SG)

(72) Inventors: Mohammad Mobin, Orefield, PA (US); Bruce A. Wilson, San Jose, CA (US); Shaohua Yang, San Jose, CA (US)

(21) Appl. No.: 15/008,278

(22) Filed: Jan. 27, 2016

(51) Int. Cl. G06F 13/362; G06F 13/42

(52) U.S. Cl. CPC G06F 13/362; G06F 13/4282

(57) ABSTRACT

Embodiments are related to systems and methods for data transfer, and more particularly to systems and methods for providing non-standard bus information.

### FIELD OF THE INVENTION

Embodiments are related to systems and methods for data transfer, and more particularly to systems and methods for providing non-standard bus information.

### BACKGROUND

A number of data transfer systems have been developed. Some transfer systems transfer information in serial. To increase data transfer rates the period between bit periods is decreased. While such reduction in period results in increased transfer rates, in results in a corresponding decrease in sampling window. Decreasing the sampling window increases the probability for data errors due to sampling inaccuracy. To assure an accurate representation of the sampling window, a receiving device may characterize the sampling window and share such information with a transferring partner device. However, sharing such window characterization information is problematic.

Hence, for at least the aforementioned reasons, there exists a need in the art for advanced systems and methods for assuring proper transfers.

### SUMMARY

Embodiments are related to systems and methods for data transfer, and more particularly to systems and methods for providing non-standard bus information.

This summary provides only a general outline of some embodiments of the invention. The phrases “in one embodiment,” “according to one embodiment,” “in various embodiments”, “in one or more embodiments”, “in particular embodiments” and the like generally mean the particular feature, structure, or characteristic following the phrase is included in at least one embodiment of the present invention, and may be included in more than one embodiment of the present invention. Importantly, such phrases do not necessarily refer to the same embodiment. Many other embodiments of the invention will become more fully apparent from the following detailed description, the appended claims and the accompanying drawings.

### BRIEF DESCRIPTION OF THE FIGURES

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 shows a bus based system including a target device having selectable margin response circuitry in accordance with various embodiments of the present inventions;

FIG. 2 graphically depicts an example data signal eye that may be characterized and represented using systems and/or methods in accordance with different embodiments of the present inventions;

FIG. 3 depicts a target device including selectable margin response circuitry in accordance with some embodiments of the present inventions; and

FIG. 4 is a flow diagram showing a method for eye detection in accordance with one or more embodiments of the present inventions.

### DETAILED DESCRIPTION OF SOME EMBODIMENTS

Embodiments are related to systems and methods for data transfer, and more particularly to systems and methods for providing non-standard bus information.

Various embodiments of the present invention provide data processing systems that include: a bus protocol receiver circuit, a characterization circuit, an authentication circuit, a selector circuit, and a bus protocol transmitter circuit. The bus protocol receiver circuit is operable to receive a bus request from a requesting device via a bus. The characterization circuit is operable to calculate a margin of an input included as part of the bus request, and to provide the margin as a proprietary margin output. The input is one or more instances of a received target identification code. The authentication circuit is operable to compare a target identification code output with a internal identification code to yield an authentication output. The target identification code output is generated using the one or more instances of the received target identification code. The selector circuit is operable to select one of the proprietary margin output or a generic margin output as a selected output based at least in part on the authentication output. The bus protocol transmitter circuit operable to transmit the selected output to the requesting device via the bus. In some instances of the aforementioned embodiments, the bus is a PCIe bus.

In some instances of the aforementioned embodiments, the bus protocol transmitter circuit is configured to communicate with the requesting device without ever indicating a result of comparing target identification code output with the internal identification code. In various instances of the aforementioned embodiments, the data processing system is implemented as part of a storage device. In some instances of the aforementioned embodiments, the data processing system is implemented as part of an integrated circuit.

In various instances of the aforementioned embodiments, the generic margin output is programmed into a register prior to receiving the bus request. In some cases, the generic margin output is a predefined set of margin information which if abided by would guarantee proper communication with the requesting device via the bus. In other cases, the generic margin output is a predefined set of margin information published as part of a protocol of the bus. In yet other cases, the generic margin output is a predefined set of margin information which if abided by may possibly result in proper communication with the requesting device via the bus. In yet further cases, the generic margin output is a null data set.

In one or more instances of the aforementioned embodiments, the proprietary margin output includes one or more of: a left data eye margin, a right data eye margin, an upper data eye margin, and/or a lower data eye margin.

Other embodiments of the present invention provide storage devices that include a bus communication integrated circuit. The bus communication integrated circuit itself includes: a bus protocol receiver circuit, a characterization circuit, an authentication circuit, a selector circuit, and a bus protocol transmitter circuit. The bus protocol receiver circuit is operable to receive a bus request from a requesting device via a bus. The characterization circuit is operable to calculate a margin of an input included as part of the bus request, and to provide the margin as a proprietary margin output. The input is one or more instances of a received target identification code. The authentication circuit is operable to compare a target identification code output with a internal identification code to yield an authentication output. The target identification code output is generated using the one or more instances of the received target identification code. The selector circuit is operable to select one of the proprietary margin output or a generic margin output as a selected output based at least in part on the authentication output. The bus protocol transmitter circuit operable to transmit the selected output to the requesting device via the bus. In some instances of the aforementioned embodiments, the bus is a PCIe bus

Yet other embodiments of the present invention provide methods for establishing communication across a bus. The methods include: receiving a bus request from a requesting device via a bus; using a characterization circuit to: calculate a margin of an input included as part of the bus request, and to provide the margin as a proprietary margin output, where the input is one or more instances of a received target identification code; comparing a target identification code output with a internal identification code to yield an authentication output, wherein the target identification code output is generated using the one or more instances of the received target identification code; selecting one of the proprietary margin output or a generic margin output as a selected output based at least in part on the authentication output; and transmitting the selected output to the requesting device via the bus. In some instances of the aforementioned embodiments, the bus is a PCIe bus.

In various instances of the aforementioned embodiments, transmitting the selected output to the requesting device via the bus is done without ever indicating a result of comparing target identification code output with the internal identification code.

In various instances of the aforementioned embodiments, the generic margin output is a predefined set of margin information which if abided by would guarantee proper communication with the requesting device via the bus. In other instances, the generic margin output is a predefined set of margin information published as part of a protocol of the bus. In yet other instances, the generic margin output is a predefined set of margin information which if abided by may possibly result in proper communication with the requesting device via the bus. In yet further instances, the generic margin output is a null data set. In some cases, the proprietary margin output includes one or more of: a left data eye margin, a right data eye margin, an upper data eye margin, and/or a lower data eye margin.

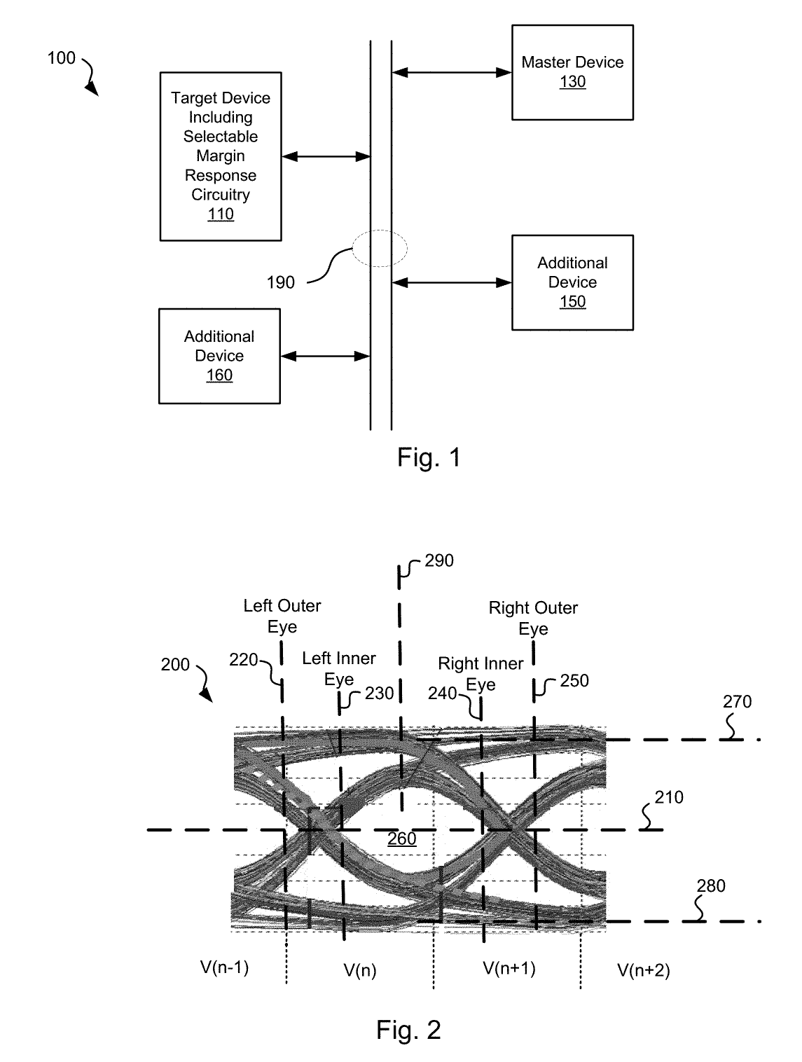

Turning to FIG. 1, a bus based system 100 is shown that includes a master device 130, a target device 110, and additional devices 150, 160 all communicably connected via a bus 190. In some embodiments bus 190 is a PCIe bus as is known in the art. Based upon the disclosure provided herein, one of ordinary skill in the art will recognize other busses that may be used in relation to different embodiments of the inventions. Master device 130 may be any device known in the art that is capable of initiating a communication via bus 190. Master device 130 may in some cases additionally include circuitry capable of responding to communication requests initiated by other devices on bus 190. In one particular embodiment, master device 130 connects other devices on bus 190 to a host (not shown). Based upon the disclosure provided herein, one of ordinary skill in the art will recognize a variety of devices and device functions that may be used as master device 130. Target device 110 may be any device known in the art that is capable of engaging in a communication with a master device via bus 190. Target device 110 may in some cases additionally include circuitry capable of initiating communication via bus 190. In one particular embodiment, target device 110 connects other devices on bus 190 to a storage device (not shown). Based upon the disclosure provided herein, one of ordinary skill in the art will recognize a variety of devices and device functions that may be used as master device 130. In some embodiments, both target device 110 and master device 130 may include the same bus communication capabilities that are standard to the operation of bus 190. Additional devices 150, 160 may be other target and/or master devices serving other functions within system 100.

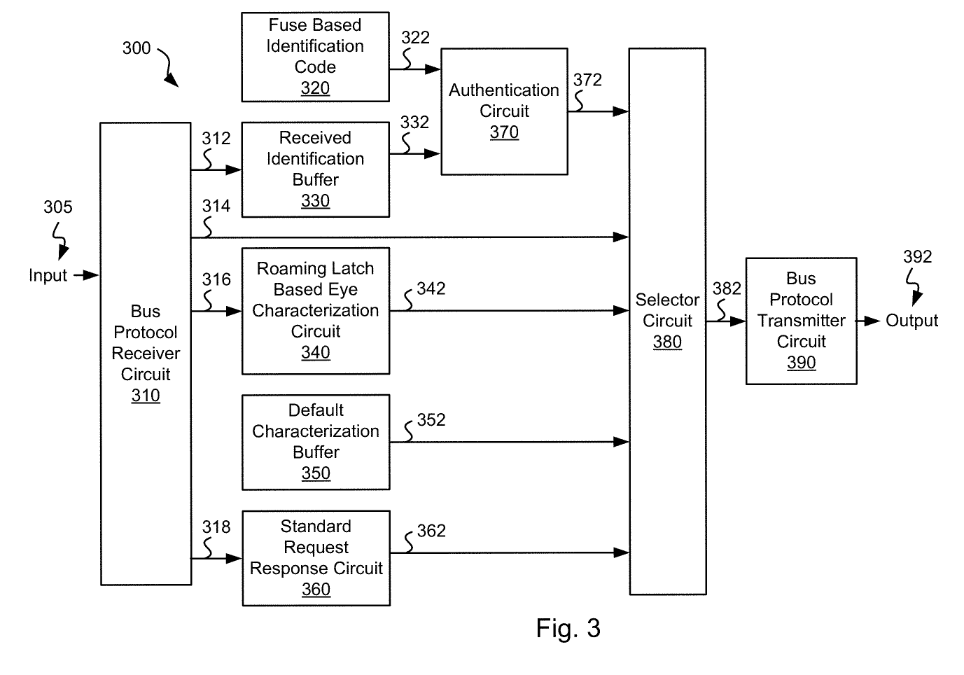

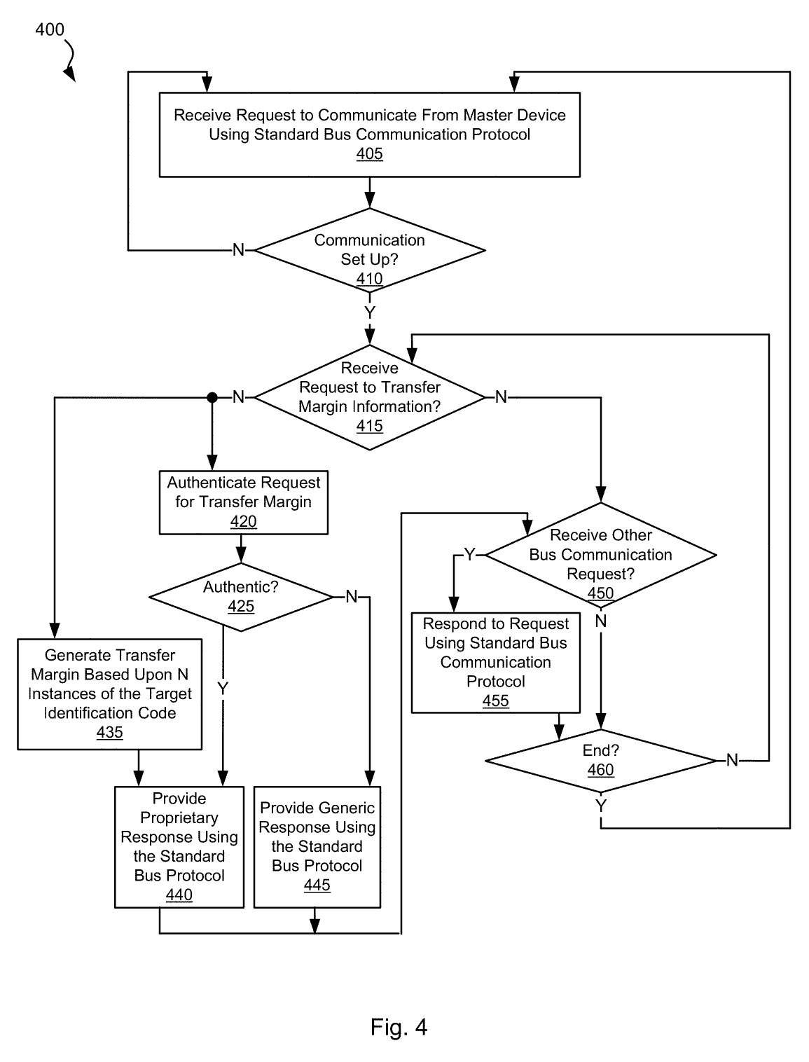

Target device 110 includes selectable margin response circuitry in accordance with one or more embodiments of the present inventions. Such selectable margin response circuitry is capable of responding to a request for margin information from a requesting device (e.g., 130). Such margin information may include, but is not limited to, a left eye margin, a right eye margin, an upper eye margin, and a lower eye margin. This margin information is calculated based upon data transferred from a master device, and is selectably sharable when requested by the master device. In particular, where the master device identifies itself to target device 130 as authorized to receive margin information, target device 110 provides the calculated margin information to the master device 190 without alerting other devices on bus 190 of the transfer. Alternatively, where the master device identifies itself to target device 130 as not authorized to receive margin information, target device 110 provides default margin information to the master device 190 without alerting other devices on bus 190 of the transfer. As used herein, “default margin information” is used in its broadest sense to mean a set of information other than the actual margin information for the device. Thus, for example, such default margin information may be, but is not limited to, a predefined set of margin information which if abided by would guarantee proper operation of a given target device, the predefined margin information for bus 190, a predefined set of margin information which if abided by may possibly result in proper operation of a given target device, or no information at all. FIG. 2 shows an example data signal eye relative to which an example set of margin information is described. FIG. 3 shows one implementation of a target device including selectable margin response circuitry that may be used in place of target device 110. FIG. 4 is a flow diagram showing a method for selective margin response that may be implemented in relation to target device 110.

Turning to FIG. 2, a graphical depiction 200 of an example data signal eye is shown that may be characterized and represented using systems and/or methods in accordance with different embodiments of the present inventions. Graphical depiction 200 shows a number of symbol instances (e.g., V(n−1), V(n), V(n+1), V(n+2) separated by dotted lines) of a the serial data superimposed on upon the other. The superimposed symbol instances show a numbed of data transitions from 1->0, 0->1, 1-> and 0->0. These superimposed symbol instances define an eye 260. As eye 260 is defined by the superimposition of a number of symbol instances and therefore there is some distance between an outer edges and inner edges of eye 260. In particular, a left outer edge 220 is offset from a left inner edge 230 at the left side of eye 260; and a right outer edge 250 is offset from a right inner edge 240 at the right side of eye 260. Sampling of the signal is optimally performed using a clock that is centered within eye 260 at a presumed horizontal eye location 290 using a threshold that is centered within eye 260 at a presumed vertical eye location 210. A left eye margin, a right eye margin, an upper margin, and a lower margin are characterized as the size of the opening of eye relative to presumed vertical eye location 210 or presumed horizontal eye location 290. In some embodiments, the left eye margin is calculated as a percentage of the time between left inner edge 230 and presumed horizontal eye location 290, the right eye margin is calculated as a percentage of the time between right inner edge 240 and presumed horizontal eye location 290, upper margin is calculated as a percentage of the voltage difference between an upper eye voltage level 270 and presumed vertical eye location 210, and lower margin is calculated as a percentage of the voltage difference between a lower eye voltage level 280 and presumed vertical eye location 210. Determining the characteristics of eye 260, and generating margin information based upon the determined characteristics may be done using any methods, circuitry and/or systems known in the art. Based upon the disclosure provided herein, one of ordinary skill in the art will recognize a variety of margin information that may be generated upon characterizing a signal eye in accordance with various embodiments of the present invention.

Turning to FIG. 3, a target device 300 including selectable margin response circuitry is shown in accordance with some embodiments of the present inventions. Target device 300 includes a bus protocol receiver circuit 310 that receives an input 305 from a bus (not shown), and parses input 305 to separate a margin transfer request from other types of requests received via the bus. Bus protocol receiver circuit 310 may be any circuit known in the art that is capable of receiving and parsing information received from a bus. In contrast, however, to a standard bus protocol circuit, bus protocol receiver circuit 310 separates a margin transfer request from other standard requests. In one particular embodiment, bus protocol receiver circuit 310 provides for receiving incoming communications via a PCIe bus, and parsing the communications to separate a margin transfer request from other types of requests.

When a request other than a margin transfer request is received as input 305, bus protocol receiver circuit 310 provides the received request as a request output 318 to a standard request response circuit 360. Such other types of requests may include any bus transaction between a requesting and receiving device other than a request to transfer margin information. For example, the request may be a request to read information from a storage medium controlled by target device 300. Based upon the disclosure provided herein, one of ordinary skill in the art will recognize a variety of bus transactions that may be supported by standard request response circuit 360. Standard request response circuit 360 generates a formulated response to the request received as input 305, and provides the formulated response as a response output 362 to a selector circuit 380. Standard request response circuit 360 may be any circuit known in the art that is capable of processing bus request and provided a response to such a bus request.

Alternatively, when a margin transfer request is received as input 305, bus protocol receiver circuit 310 provides the received request as a request output 312 to a received identification buffer 330, and as a request output 316 to a roaming latch based eye characterization circuit 340. Such a margin transfer request includes N-instances of a target identification code. Received identification buffer 330 performs a data detection process on the N-instances of a target identification code to generate and store a unified target identification code. The unified target identification code is provided as a target identification code output 332 to an authentication circuit 370.

Authentication circuit 370 compares target identification code output 332 with an internal identification code 322. A predefined identification code 320 is programmed into target device 300 by selectively burning one or more fuses to yield fuse based identification code 320 that is provided to authentication circuit 370 as internal identification code 322. Where target identification code output 332 matches internal identification code 322, the device that issued the request received as input 305 is authenticated. Such authentication is indicated by asserting an authentication output 372 that is provided to selector circuit 380. Otherwise, where target identification code output 332 does not match internal identification code 322, the device that issued the request received as input 305 is not authenticated. Such a failure to authenticate is indicated by de-asserting authentication output 372.

Roaming latch based eye characterization circuit 340 performs a proprietary margin characterization on the N-instances of the target identification code to generate a proprietary transfer margin output 342. In some embodiments, the generated transfer margin output 342 includes information about a data signal eye such as, for example, a left eye margin, a right eye margin, an upper margin, and a lower margin. Determining the characteristics of a data signal eye, and generating the transfer margin information based upon the determined characteristics may be done using any methods, circuitry and/or systems known in the art. Based upon the disclosure provided herein, one of ordinary skill in the art will recognize a variety of margin information that may be generated upon characterizing a signal eye in accordance with various embodiments of the present invention. A default characterization buffer 350 stores default margin information that is provided as a generic margin output 352 to selector circuit 380. The default margin information may be either fixed or programmed into target device 300.

Bus protocol receiver circuit 310 additionally provides a status output 314 to selector circuit 380. When input data 305 includes a request for margin information, status output 314 is asserted to indicate the received request for margin information. Otherwise, when input data 305 does not include a request for margin information, status output 314 is de-asserted. Using a combination of status output 314 and authentication output 372, selector circuit 380 selects one of response output 362, proprietary transfer margin output 342, or generic margin output 352 as a request response 382. In particular, where status output 314 does not indicate receipt of a request for margin information, selector circuit 380 provides response output 362 as request response 382. Alternatively, where status output 314 indicates receipt of a request for margin information and authenticated output indicates a failure to authenticate the device making the request, selector circuit 380 provides generic margin output 352 as request response 382. Alternatively, where status output 314 indicates receipt of a request for margin information and authenticated output indicates an authentication of the device making the request, selector circuit 380 provides proprietary margin output 342 as request response 382.

Request response 382 is provided to a bus protocol transmitter circuit 390. Bus protocol transmitter circuit 390 may be any circuit known in the art that is capable of formatting a response for communication via a bus. In cases where the bus is a PCIe bus, bus protocol transmitter circuit 390 formats request response 382 as a PCIe response that is provided as an output 392.

Turning to FIG. 4, a flow diagram 400 shows a method for eye detection in accordance with one or more embodiments of the present inventions. Following flow diagram 400, a request to communicate is received from a master device (block 405). The request is received in accordance with a protocol governing operation of a bus connecting the master device and the receiving or target device. In some embodiments, the bus is a PCIe bus and thus the protocol governing operation of the bus in such an embodiment is the PCIe bus protocol. Based upon the disclosure provided herein, one of ordinary skill in the art will recognize other busses and corresponding bus protocols that may be used in relation to different embodiments of the inventions. In accordance with the received request, the target device and master device operate to set up a communication between the devices.

Where a communication is set up between the master device and the target device (block 410), it is determined whether a request to transfer margin information from the target device to the master device has been received from the master device (block 415). A request for margin information is done when the master device sends a target identification code shared by the maker of the target device to the maker of the master device, and the target device sends a master identification code shared by the maker of the master device to the maker of the target device. The target identification code is programmed into the master device, and the master identification code is programmed into the target device. In operation, the master device repeatedly sends the target identification code N-times to the target device via the bus and upon receipt the target device acknowledges receipt of the target identification code, but the target device remains silent about whether the received target identification code was correct or not. In some embodiments, N is thirty-two. Based upon the disclosure provided herein, one of ordinary skill in the art will recognize other values for N that may be used in relation to different embodiments. Similarly, the target device repeatedly sends the master identification code N-times to the master device via the bus and upon receipt the master device acknowledges receipt of the master identification code, but the master device remains silent about whether the received master identification code was correct or not. Notably, identification codes are exchanged without providing an external indication of a result of authentication or a failure to authenticate.

Where a request to transfer margin information is received (block 415), the data received as part of the request (i.e., the N-instances of the target identification code) is analyzed to generate the transfer margin (block 435). In some embodiments, the generated transfer margin includes information about a data signal eye such as, for example, a left eye margin, a right eye margin, an upper margin, and a lower margin. Determining the characteristics of a data signal eye, and generating the transfer margin information based upon the determined characteristics may be done using any methods, circuitry and/or systems known in the art. Based upon the disclosure provided herein, one of ordinary skill in the art will recognize a variety of margin information that may be generated upon characterizing a signal eye in accordance with various embodiments of the present invention.

In parallel to generating the transfer margin (block 435), the target identification code received as part of the request is compared with an identification code internal to the target device (block 420). Where the received target identification code matches the internal identification code, the master device is authenticated. Otherwise, where the received target identification code matches the internal identification code, the master device is authenticated. Based upon the aforementioned comparison, it is determined whether the received target identification code is authentic (block 425). Where the received target identification code does not match the internal identification code (block 425), a generic response is provided from the target device to the master device using the standard bus protocol (block 445). The generic response includes default margin information and notably does not include an indication of whether the master device passed or failed the authentication. Otherwise, where the received target identification code does match the internal identification code (block 425), a proprietary response is provided from the target device to the master device using the standard bus protocol (block 440). The proprietary response includes the transfer margin information generated based upon the N-instances of the target identification code sent from the master device. Notably, the proprietary response does not include an indication of whether the master device passed or failed the authentication.

As providing either the proprietary response or the generic response does not indicate to the master device whether the authentication succeeded or failed (blocks 440, 445), the master device is not necessarily aware of whether it received the proprietary response or the generic response. In some cases, while not shown, an authentication process similar to that performed by the target device using the target identification code is performed by the master device using the master identification code provided by the target device. Where the master device is able to authenticate the target device using the received master identification code, the master device assumes that the response received to the request for margin information is the proprietary response. Otherwise, where the master device is not able to authenticate the target device using the received master identification code, the master device assumes that the response received to the request for margin information is the generic response.

Where a request to transfer margin information is not received or has already received a response (block 415), it is determined whether a bus communication request other than a request to transfer margin information has been received (block 450). Where another bus communication request has been received (block 450), the target device formulates a response, and provides the formulated response to the requesting master device via the bus using a standard bus communication protocol (block 455). Such other bus communication requests and corresponding responses may include any bus transaction between a requesting and receiving device other than a request to transfer margin information. Where either no additional bus communication request has been received (block 450) or a received bus communication request has completed (block 455), it is determined whether the communication session is over (block 460). This may be determined using the standard bus protocol indicating the completion of a communication session. Where the communication session is not over (block 460), the processes beginning at block 415 are repeated. Otherwise, where the communication session is over (block 460), the start of a new communication session is begun when a new request for communication is received and the processes beginning at block 405 are repeated.

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent—albeit such an entirely software or firmware system would not be a circuit. In other cases, the one part of a given system, block or circuit may be implemented in software or firmware, while other parts are implemented in hardware.

In conclusion, the invention provides novel systems, devices, methods and arrangements for data processing. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A data processing system, the system comprising:
a bus protocol receiver circuit operable to receive a bus request from a requesting device via a bus;
a characterization circuit operable to calculate a margin of an input included as part of the bus request, and to provide the margin as a proprietary margin output, wherein the input is one or more instances of a received target identification code;
an authentication circuit operable to compare a target identification code output with a internal identification code to yield an authentication output, wherein the target identification code output is generated using the one or more instances of the received target identification code;
a selector circuit operable to select one of the proprietary margin output or a generic margin output as a selected output based at least in part on the authentication output; and
a bus protocol transmitter circuit operable to transmit the selected output to the requesting device via the bus.

2. The system of claim 1, wherein the bus protocol transmitter circuit is configured to communicate with the requesting device without ever indicating a result of comparing target identification code output with the internal identification code.

3. The data processing system of claim 1, wherein the data processing system is implemented as part of a storage device.

4. The data processing system of claim 1, wherein the data processing system is implemented as part of an integrated circuit.

5. The data processing system of claim 1, wherein the generic margin output is programmed into a register prior to receiving the bus request.

6. The data processing system of claim 5, wherein the generic margin output is a predefined set of margin information which if abided by would guarantee proper communication with the requesting device via the bus.

7. The data processing system of claim 5, wherein the generic margin output is a predefined set of margin information published as part of a protocol of the bus.

8. The data processing system of claim 5, wherein the generic margin output is a predefined set of margin information which if abided by may possibly result in proper communication with the requesting device via the bus.

9. The data processing system of claim 5, wherein the generic margin output is a null data set.

10. The data processing system of claim 1, wherein the bus is a PCIe bus.

11. The data processing system of claim 1, wherein the proprietary margin output includes one or more of: a left data eye margin, a right data eye margin, an upper data eye margin, and/or a lower data eye margin.

12. A method for establishing communication across a bus, the method comprising:
receiving a bus request from a requesting device via a bus;
using a characterization circuit to: calculate a margin of an input included as part of the bus request, and to provide the margin as a proprietary margin output, wherein the input is one or more instances of a received target identification code;
comparing a target identification code output with a internal identification code to yield an authentication output, wherein the target identification code output is generated using the one or more instances of the received target identification code;
selecting one of the proprietary margin output or a generic margin output as a selected output based at least in part on the authentication output; and
transmitting the selected output to the requesting device via the bus.

13. The method of claim 12, wherein transmitting the selected output to the requesting device via the bus is done without ever indicating a result of comparing target identification code output with the internal identification code.

14. The method of claim 12, wherein the proprietary margin output includes one or more of: a left data eye margin, a right data eye margin, an upper data eye margin, and/or a lower data eye margin.

15. The method of claim 12, wherein the generic margin output is a predefined set of margin information which if abided by would guarantee proper communication with the requesting device via the bus.

16. The method of claim 12, wherein the generic margin output is a predefined set of margin information published as part of a protocol of the bus.

17. The method of claim 12, wherein the generic margin output is a predefined set of margin information which if abided by may possibly result in proper communication with the requesting device via the bus.

18. The method of claim 12, wherein the generic margin output is a null data set.

19. The method of claim 12, wherein the bus is a PCIe bus.

20. A storage device, the storage device comprising:
a bus communication integrated circuit, wherein the bus communication integrated circuit includes:
a bus protocol receiver circuit operable to receive a bus request from a requesting device via a bus;
a characterization circuit operable to calculate a margin of an input included as part of the bus request, and to provide the margin as a proprietary margin output, wherein the input is one or more instances of a received target identification code;
an authentication circuit operable to compare a target identification code output with a internal identification code to yield an authentication output, wherein the target identification code output is generated using the one or more instances of the received target identification code;
a selector circuit operable to select one of the proprietary margin output or a generic margin output as a selected output based at least in part on the authentication output; and
a bus protocol transmitter circuit operable to transmit the selected output to the requesting device via the bus.
